(19) United States
(12) Patent Application Publication
(10) Pub. No.: US 2020/0226162 A1
(43) Pub. Date: Jul. 16, 2020

(54) Automated Reporting System

(71) Applicant: Canoe Software Inc., New York, NY (US)

(72) Inventors: Samuel Klatt, NY, NY (US); Wei Wang, NY, NY (US)

(73) Assignee: Canoe Software Inc., New York, NY (US)

(21) Appl. No.: 16/635,833

(22) PCT Filed: Aug. 2, 2018
(86) PCT No.: PCT/US2018/045001

§ 371 Date: Jan. 31, 2020

Related U.S. Application Data
(60) Provisional application No. 62/540,279, filed on Aug. 2, 2017.

(51) Int. Cl. G06F 16/33; G06F 16/332; G06F 16/335; G06F 16/93; G06F 40/126; G06F 40/163

(52) U.S. Cl. CPC G06F 16/3334; G06F 16/3329; G06F 40/163; G06F 16/93; G06F 40/126; G06F 16/335

(57) ABSTRACT

The technology relates to extracting data from a document. In this regard, one or more processors may receive a document. The one or more processors may cover the document to a text format and perform data extraction from the converted document. The one or more processors may generate a result set including at least some of the extracted data.

The present application claims the benefit of the filing date of U.S. Provisional Application No. 62/540,279, filed Aug. 2, 2017, the disclosure of which is hereby incorporated herein by reference.

### FIELD OF THE INVENTION

The present application relates to automated computer-implemented methods and systems for retrieving and reporting relevant data from electronic records.

### BACKGROUND OF THE INVENTION

Communication of data via electronic documents has increased exponentially over the past few decades. In this regard, many businesses and organizations (i.e., entities) have abandoned the use of postal mail to provide information in favor of electronic communications. Electronic communication methods, such as email, text messages, online file hosting sites, etc., provide near instantaneous delivery of information to recipients without the need for postage fees. However, the sheer volume of such communications being sent may overwhelm recipients. Further, the innumerable styles and layouts of such communications may result in the inability of recipients to find relevant information. As a result, the recipients may miss information or ignore communications entirely.

### BRIEF SUMMARY

One aspect of the disclosure provides a method for extracting data from a document, the method comprising: receiving, with one or more processors, the document; converting, with the one or more processors, the document to a text format; performing, with the one or more processors, data extraction from the converted document; and generating, with the one or more processors, a result set including at least some of the extracted data.

In some instances, performing the data extraction includes: receiving, with the one or more processors, a selection of text from the converted document, wherein the selection of text includes one or more portions of text; and assigning, with the one or more processors, a respective tag to each of the one or more portions of text. In some examples the selection of text from the converted document is based on predefined criteria associated with a low level algorithm.

In some examples, the extracted data is validated. In some instances, in the event the validation of the extracted data fails: the method includes receiving, from a user, a selection of text from the converted document, wherein the selection of text includes one or more portions of text; and assigning, with the one or more processors, a respective tag to each of the one or more portions of text.

In some instances, prior to performing the data extraction, validating that the conversion was successful.

In some examples the document includes one or more of tables, fields, Unicode characters, and numbers.

Another aspect of the disclosure provides a system for extracting data from a document, the system comprising: one or more processors configured to: receive the document; convert the document to a text format; perform data extraction from the converted document; and generate a result set including at least some of the extracted data.

Another aspect of the disclosure provides a non-transitory computer-readable medium storing instructions, which when executed by one or more processors, cause the one or more processors to: receive a document; convert the document to a text format; perform data extraction from the converted document; and generate a result set including at least some of the extracted data.

### BRIEF DESCRIPTION OF THE DRAWINGS

A more complete understanding of the invention may be obtained by reading the following description of specific illustrative embodiments of the invention in conjunction with the appended drawing in which:

FIG. 1 is a flow diagram of retrieving and reporting relevant portions of electronic communication in accordance with embodiments of the invention.

FIG. 2 is a functional diagram of an example system in accordance with aspects of the disclosure.

FIG. 3 is a pictorial diagram of the example system of FIG. 2.

FIG. 4 is a schematic diagram illustrating a method according to an embodiment of the invention.

FIG. 5 is an illustration of an example document according to an embodiment of the invention.

FIG. 6 is a schematic diagram illustrating a method according to an embodiment of the invention.

FIG. 7 is an illustration of an example of a user interface according to an embodiment of the invention.

FIG. 8 is an illustration of an example document according to an embodiment of the invention.

FIG. 9 is a schematic diagram illustrating a method according to an embodiment of the invention.

### DETAILED DESCRIPTION

### Overview

The following includes a description of the best modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

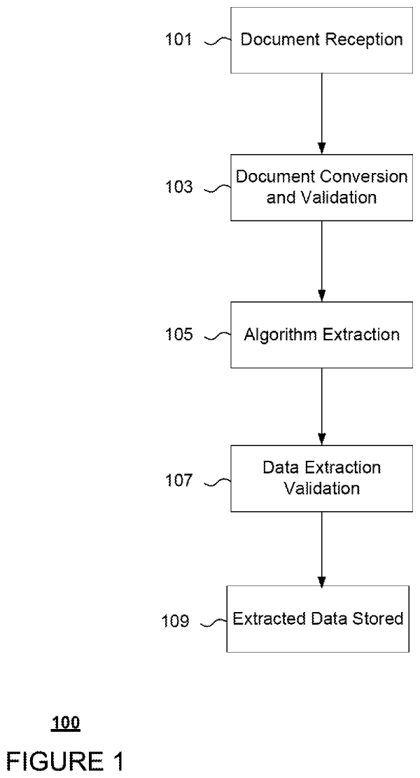

This technology relates to, by way of example, automated extraction and reporting of information from electronic communications. For instance, an electronic communication, which may include one or more documents, may be forwarded to a processing server, as shown at block 101 in the flow diagram 100 of FIG. 1. Upon receiving the electronic communication, the processing server may convert the document to text and validate the conversion was successful, as shown in blocks 103 and 105. The processing server may then apply an algorithm to the text to extract relevant data, as shown in block 107. A validation may then be performed to assure the extraction was successful as shown in block 109. The extracted data may then be stored and reported to a client as shown in block 111.

### Example Systems

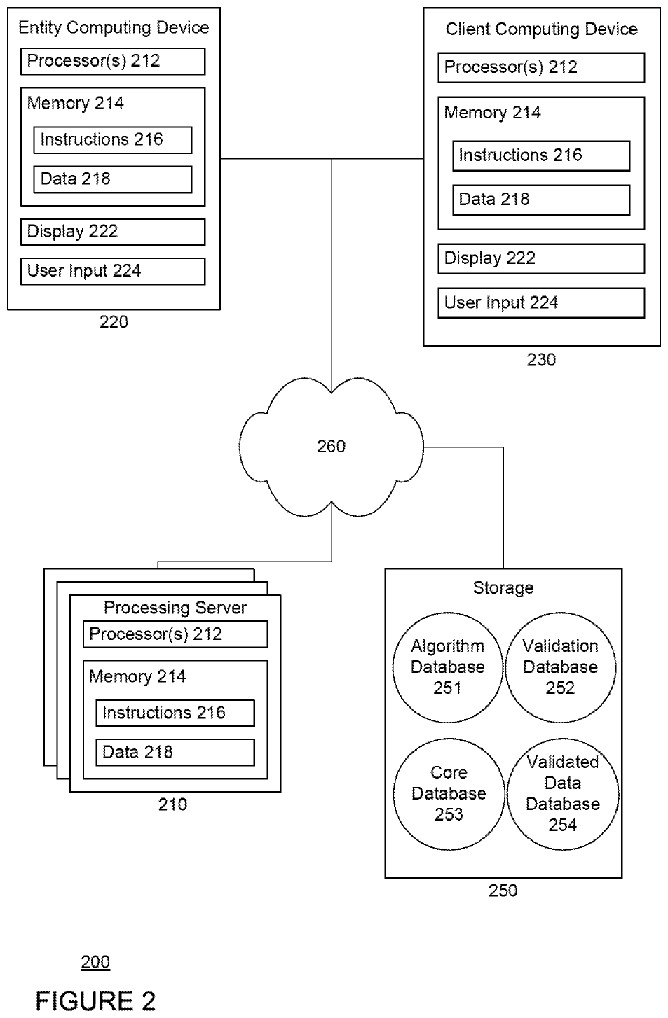

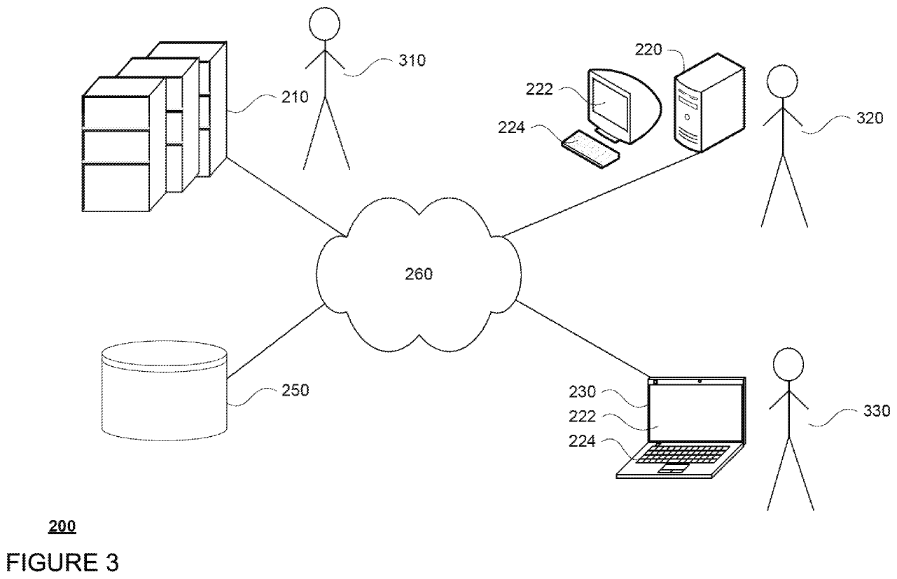

FIGS. 2 and 3 include an example system 100 in which the features described herein may be implemented. It should not be considered as limiting the scope of the disclosure or usefulness of the features described herein. In this example, system 200 may include computing devices 210-230, which include processing server 210, entity computing device 220, and client computing device 230, as well as storage system 250. Each computing device 210-230 can contain one or more processors 212, one or more memory 214, and other components commonly found in general and special purpose computing devices.

Memory 214 of each of computing devices 210, 220, and 130 can store information accessible by the one or more processors 212, including instructions 216 that can be executed by the one or more processors 212. Memory can also include data 218 that can be stored, manipulated, or retrieved by the processor. Such data 218 may also be used for executing the instructions 216 and/or for performing other functions. The memory can be of any non-transitory type capable of storing information accessible by the processor, such as a hard-drive, solid state hard-drive, memory card, ROM, RAM, DVD, CD-ROM, write-capable, read-only memories, and other such non-transitory types of memory.

The instructions 216 can be any set of instructions to be executed directly or indirectly by the one or more processors. The instructions may be stored in any format which may be read and executed by the processor. In some embodiments the instructions may be stored in a location separate from the computing device, such as in a remote network storage drive. The operations which the instructions cause the one or more processors to execute are explained in more detail below. The terms “instructions,” “functions,” “application,” “steps,” and “programs” can be used interchangeably herein. Data 218 may be read and executed by the one or more processors 212 in accordance with the instructions 216.

Data 218 may be retrieved, stored or modified by the one or more processors 212 in accordance with the instructions 216. For instance, although the subject matter described herein is not limited by any particular data structure. The data can also be formatted in any computing device-readable format. Moreover, the data can comprise any information sufficient to identify other relevant information, such as numbers, descriptive text, proprietary codes, pointers, references to data stored in other memories such as at other network locations, or information that is used by a function to calculate the other relevant information.

The one or more processors 212 can be any conventional processors, such as commercially available CPUs from Intel, AMD, or Apple. Alternatively, the processors can be dedicated components such as an application specific integrated circuit (“ASIC”) or other hardware-based processors, such as ARM processors or System on Chips (SoCs). Alternatively, the processors can be dedicated components such as an application specific integrated circuit (“ASIC”) or other hardware-based processor.

Although FIG. 2 functionally illustrates the components of the computing devices 210 (i.e., processor, memory, etc.,) as being single components, the components may actually comprise multiple processors, computers, computing devices, or memories that may or may not be stored within the same physical housing. For example, the memory can be a hard drive or other storage media located in housings different from that of the computing devices 210. The same may be true of the components within the other computing devices 220 and 230. Accordingly, references to a processor, computer, computing device, or memory will be understood to include references to a collection of processors, computers, computing devices, or memories that may or may not operate in parallel. Further, although some functions described below are indicated as taking place on a single computing device having a single processor, various aspects of the subject matter described herein can be implemented by a plurality of computing devices in series or in parallel.

Storage device 250 can be of any type of storage capable of storing information accessible by the server computing devices 210, member computing device 220, or retail computing device 240, such as a hard-drive, a solid state hard drive, NAND memory, ROM, RAM, DVD, CD-ROM, write-capable, and read-only memories. In addition, storage device 250 may include a distributed storage device where data is stored on a plurality of different storage devices which may be physically located at the same or different geographic locations, such as network attached storage. Storage device 250 may be connected to the computing devices via the network 260 as shown in FIG. 2, and/or may be directly connected to any of the computing devices 210, 220, and 230.

The network 260 and intervening nodes, described herein, can be interconnected using various protocols and systems. For example, the network 260 may be implemented via the Internet, intranets, local area networks (LAN), wide area networks (WAN), etc. Communication protocols such as Ethernet, WiFi, and HTTP, Bluetooth, LTE, 3G, 4G, Edge, etc., and various combinations of the foregoing may be used to allow the nodes to communicate.

Each of the computing devices 210, 220, and 230 may be implemented by directly and/or indirectly communicating over the network 260. In this regard, each of the computing devices 210, 220, and 230, as well as storage device 250, can be at different nodes of a network 260 and capable of directly and indirectly communicating with other nodes of network 260. As an example, each of the computing devices 210-230 may include web servers capable of communicating with storage system 250 via the network. For example, one or more of server computing devices 210 may use network 260 to transmit and present information to a user, such as users 310-330, on a display, such as displays 222 of computing devices 210-230.

Although only a few computing devices are depicted in FIGS. 2-3, it should be appreciated that a typical system can include a large number of connected computing devices 210, 220, and 230, with each different computing device being at a different node of the network 260. For example, each client 330, of which there may be an indefinite number, may have at least one client computing device 230. Similarly, each processor 330 may typically have at least one processing server 210. As a further example, each of the computing devices 210 may include web servers, operating at different nodes on the network 260, capable of communicating with storage system 250 as well as with computing devices 220 and 230 via the network. For example, one or more of server computing devices 210 may use network 260 to transmit and present information to a user, such as user 220 or 230, on a display, such as displays 222 of computing devices 220 or 230.

Each of the computing devices 220 and 230 may be configured similarly to the server computing devices 210, with one or more processors, memory and instructions as described above. Computing devices 220 and 230 may be a personal computing device intended for use by a user 220 and 230, and have all of the components normally used in connection with a personal computing device such as a central processing unit (CPU), memory (e.g., RAM and internal hard drives) storing data and instructions, a display such as displays 222, (e.g., a monitor having a screen, a touch-screen, a projector, a television, or other device that is operable to display information), and user input device 224 (e.g., a mouse, keyboard, touch-screen, or microphone). Although not shown, server computing devices 210 may also include displays and user input devices. The computing devices 210-230 may also include a camera for recording video streams and/or capturing images, speakers, a network interface device, and all of the components used for connecting these elements to one another.

Although the computing devices 220 and 230 may each comprise a full-sized personal computing device, they may alternatively comprise mobile computing devices capable of wirelessly exchanging data with a server over a network such as the Internet. By way of example only, entity computing device 220, although depicted as a personal computing device, may be a mobile phone or a device such as a wireless-enabled PDA, a tablet PC, or a netbook that is capable of obtaining information via the Internet. In another example, client computing device 230 may be a laptop computer.

The entity computing device 220 may be configured to provide specific functions in accordance with embodiments of the technology. For example, the entity computing device 220 may be programmed to allow the entity to submit documents to a client computing device or to the processing server 210. In this regard, entity computing device 220 may be able to communicate, via the network 260, with client computing devices 230 associated with the entity. In some regards, the entity computing device 220 may be programmed to automatically upload some, or all, documents to the processing server 210.

Client computing device 230 may be configured to provide specific functions in accordance with embodiments of the technology. In some embodiments the client computing device may be programmed to automatically upload documents. The client computing device 230 may be able to perform all of the methods described herein. In some embodiments the client computing device 230 may be programmed to perform all of the functions of processing server 210.

A processing company may operate one or more central servers which maintain the services offered by the processing company. In this regard, the processing server, such as processing server 210, may maintain one or more storage devices which store the received communications, as well as data objects generated by the processing company in a database. In some embodiments, one or more of the functions of the processing servers, such as processing server 210, may be implemented by any one of computing devices 220. As such, the entities may operate servers which perform the functions of the processing server 210 in place of, or in concert with the processing company's server. In this regard, the entity's computing device 220 may be programmed with the analytic company's programs to perform some or all of the operations performed by the analytic company. Similarly, the client's computing device 230 may be programmed with the analytic company's programs to perform some or all of the operations performed by the analytic company.

The processing server may be able access external sources of data. In this regard, the central server may connect to other sources of data such as servers, computing devices, and/or storage devices. These other sources of data may include the client's electronic communications, entities database of electronic communications, etc.

### Example Methods

For purposes of highlighting features of the present invention, exemplary processes for automatic reporting of data shown in FIGS. 1 and 4-8, are described herein in connection with operations performed at components of the system 200, as described in FIGS. 2 and 3. It is to be understood that the some or all of the operations performed at the client computing device 230 may be performed at the server computing devices 210 and vice versa.

The document which is processed by the processing server may be provided from a business, organization, or other such entities. In this regard, the document may be transmitted over a network, such as network 260, from an entity's device, such as entity computing device 220, to a client's device, such as client computing device 230. The document may be attached or otherwise included in one or more electronic communications, such as email, text message, FTP transfer, or other such type of electronic communications. For instance, a business may transmit an email communication with a document attached to a client's device. In some instances the electronic communication may itself be a document.

Upon receiving the document, the client computing device 230 may forward the document to a processing server, such as processing server 210. In this regard, the client's device may automatically forward documents or the entire electronic communication including the document received from predefined entities to the processing server. The document may be forwarded to the processing device via one or more electronic communications or via upload onto a website monitored or otherwise hosted by the processing server 210. In some instances the client may manual forward the document. Moreover, entities may send all documents directly to the processing server 210. The processing server may store copies of the documents either locally or on a network for future access. Although the examples described herein discuss only a single document, more than one document may be provided to the processing server.

The processing server 210 may be provided access directly to a client's emails or another such location where the client' s documents are stored, such as an online portal. As described herein, the documents may be provided from an entity to a client's email, or, in some instances, to a client's portal where documents are retrievable. The processing server may be provided with credentials and location (e.g., web address, email folder, portal location, etc.,) for accessing the client's emails or portal. In this regard, the processing server may, on a set schedule, such as hourly, daily, weekly, bi-weekly, quarterly, etc., access the client's emails or portal and retrieve the client's documents. The processing server may store copies of the documents either locally or on a network for future access.

The document may be in any format readable by the processing server. In this regard, the processing server may be configured to handle a large number of formats typically used to transfer data. For instance, the document may be in the format of pdf, scanned pdf, html, xml, excel, csv, jpeg, png, doc, and other such file formats. The document may also be an encrypted file, password protected, and/or in a compressed format, such as a ZIP or RAR format file.

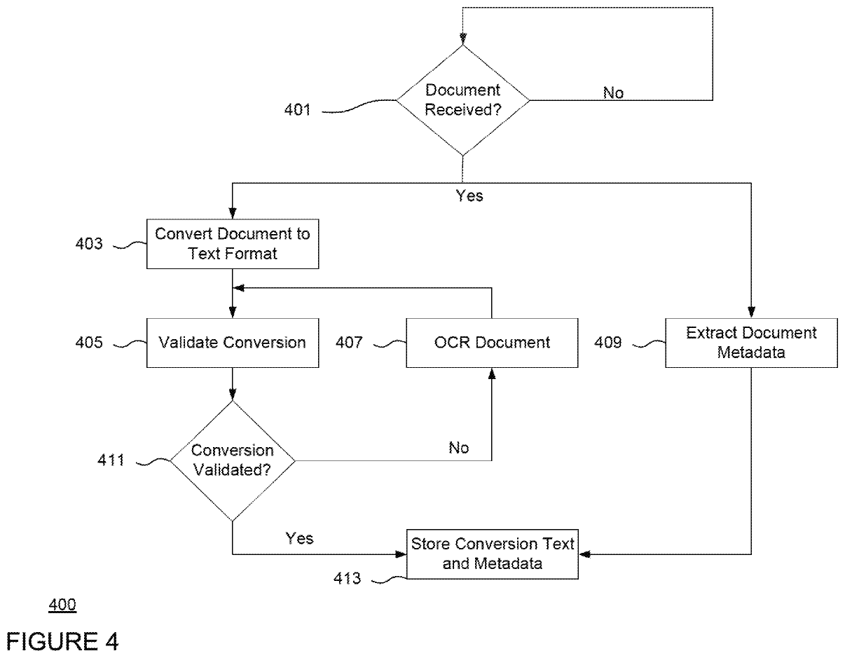

Referring to FIG. 4, a flow chart 400 of the document reception, conversion, and validation performed by the processing server 210, as outlined in blocks 101 and 103 of FIG. 1 are shown. Initially, the processing server 210 may continually or intermittently monitor for a received document, as shown in block 401. Should no document be received, the processing server 210 may continue to monitor for documents.

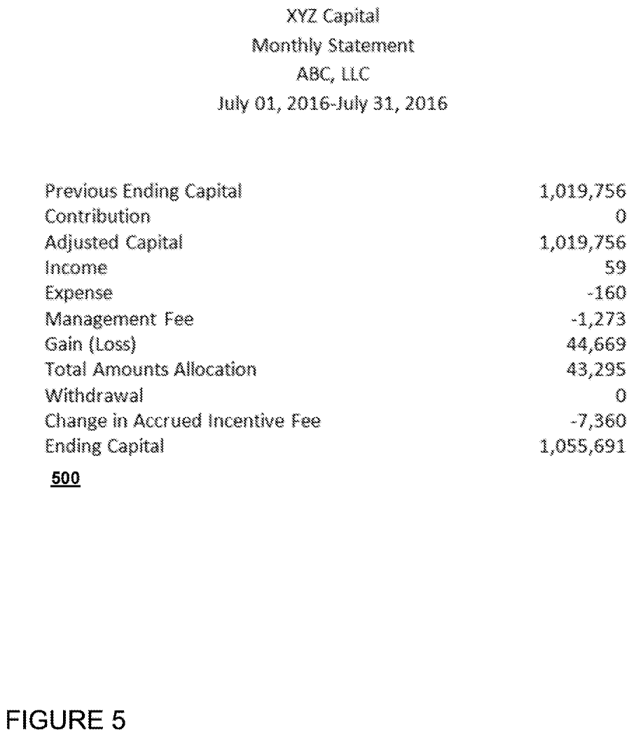

Upon receiving a document, the document may be converted to text format, as shown in block 403. In this regard known conversion software may be used to convert the document from a first file format, such as pdf, to a text format, such as a plain text format. For instance, a pdf document, such as the financial statement 500, as shown in FIG. 5 may be received. Upon receiving the financial statement 500, the processing server 210 may convert the financial statement to a text format. In the event the received document is in the format of a communication with an attachment(s), the processing server may separate each attachment(s) from the communication. Each of the attachment(s) and the communication may then be converted into a text format. In some instances the document may be in text format and the conversion steps may be skipped.

A conversion validation may be performed to determine if the conversion of the document to text format was successful, as shown in block 405 of FIG. 4. In this regard, the processing server 210 may analyze attributes of the converted text to determine if the conversion was successful. For instance, the processing server 210 may determine if the total amount of letters in the converted text is 0 and/or if the file size of the converted text is greater than a threshold of 1 byte, or more or less. If so, the conversion may be considered unsuccessful. Alternatively, if the total amount of letters is greater than 0 and/or the file size of the converted text is less than or equal to the threshold of 1 byte, the conversion may be considered successful. Although the threshold value is shown as 1 byte, the value may be any document size. The total amount of letters for a document conversion to be considered successful/unsuccessful may be more than 0. In some instances, the validation may be considered unsuccessful if the document is password protected and/or encrypted and no password or key has been provided to unlock and/or decrypt the document. As such, a user, such as user 310 may be prompted to enter a password or key before conversion and validation of the document occurs again.

As shown in block 411 of FIG. 4, in the event the conversion is unsuccessful, the document may be subjected to further processing. In this regard, the document may be analyzed with optical character recognition (OCR) software to extract text characters from the document as shown in block 407. Upon completion of the OCR analysis, the processing server 210 may again perform validation as shown in block 405. In the event validation is again determined to be unsuccessful, the processing server may alert a user that the file cannot be converted and processing of the document may stop. In some instances, the processing server may attempt OCR analysis and validation a predetermined number of times before alerting a user, such as user 310 that the document cannot be converted.

Simultaneously or consecutively to the conversion of the document to text format, the metadata of the document may be extracted, as shown in block 409. In this regard, metadata defining attributes of the file, such as origin ownership, document size, document name, etc., may be extracted from the document. For example, referring again to document 500, the document may be named “XYZ Capital—July Monthly Statement”, belong to client 330, and may be 20 mb in size. The processing server 210 may extract the metadata of document 500 including the document name, the document's owner, and document size. In some instances, metadata may be found within the text of the document. As such, the metadata within the document may be extracted after the conversion of the document to text is validated.

The converted text document may be stored in association with the extracted metadata, as shown in block 413. In this regard, after the converted text document is validated and the document's metadata is extracted, the processing server 210 may store the text and metadata, such as in memory 214 and the validated data database 254. In the event the converted text document and metadata has previously been saved, a duplicate copy may or may not be saved. Identification of duplicate copies of a document may be determined based on identification keys, such as hash values, assigned to each document provided to the processing server. In this regard, for some or all documents received by the processing server 210, the processing server may assign an identification key to each document. Upon assigning an identification key to a received document, the processing server may compare the assigned identification key to other stored documents, which were previously received and assigned an identification key. Documents with the same identification key may be considered duplicates.

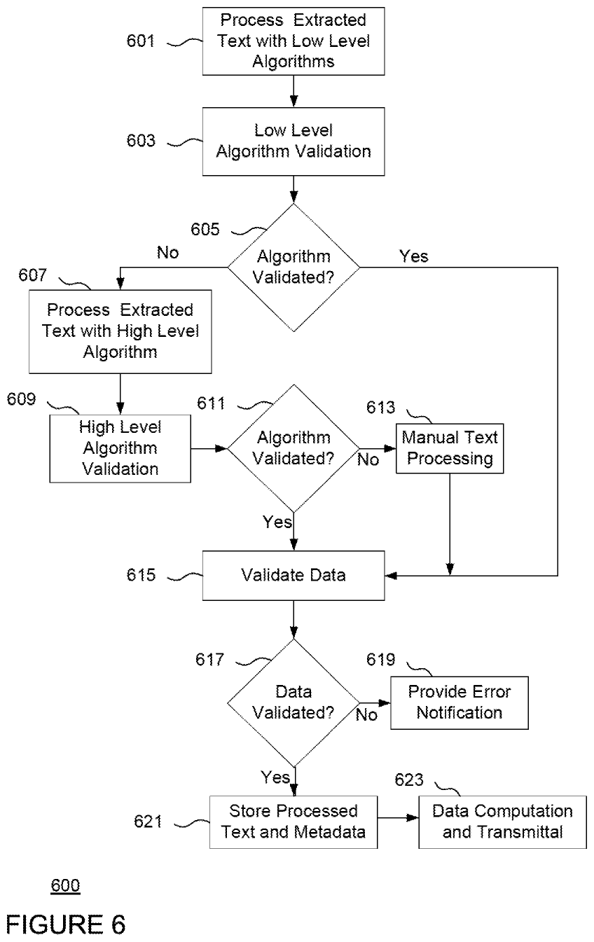

Referring now to FIG. 6, a flow chart 600 of the document extraction, extraction validation and extraction storage, as outlined in blocks 105 and 109 of FIG. 1 is shown. Extraction of relevant data (i.e., result set text,) from the converted text document may be performed by processing the converted text document with a low level algorithm as shown in block 601. As used herein text may include any fields, word blocks, numbers, Unicode characters, symbols, etc., and may be in any language. In this regard, a low level algorithm which is used to process the converted text document may be retrieved from an algorithm database from the converted text documents metadata. For instance, continuing the example with document 500, the metadata extracted from document 500 (i.e., “XYZ Capital—July Monthly Statement” and belonging to client 330) may be analyzed by processing server 210. Based on the analysis of processing server 210, a low level algorithm associated with statements issued by XYZ Capital to client 330 may be determined and retrieved from storage, such as algorithm database 251. The low level algorithm may then be applied to the converted text document and a result set text may be extracted and output. Although the example method described in relation to FIG. 6 describes the processing of a single document, the system may batch process an unlimited number of documents. In this regard, the processing server may process (i.e., extract, categorize and validate the documents,) simultaneously, or in series, a plurality of documents of any document and asset type. Categorization of documents may include associating a document with a fund, a client, and/or entities associated with a client. For instance, a fund called FrontTech Investment may have ten clients, each with a plurality of entities. Documents may be categorized to FrontTech Investments, the clients, and/or the entities.

In some instances more than one low level algorithm may be associated with extracted metadata. As such, more than one low level algorithm may be applied to the converted text document. In the event no low level algorithms are associated with the extracted metadata, the process may move to step 607.

The result set text may include relevant data from the document. In this regard, the data included in result set text may be data indicated as relevant by a client such as client 330, indicated as relevant by other users such as users 320-330. Additionally, relevant data may be data used by the processing server to generate reports to the client, as described further herein. An example result set text extracted from the converted text document 500 is shown in Table 1, below:

TABLE 1

“hedgeFundName” => “XYZ Capital”,
“entityName” => “ABC, LLC”,
“endingDate” => “July 31, 2016”,
“beginningBalance” => “1,019,765”,
“endBalance” => “1,055,691”

The result set text of each applied low level algorithm may be validated. In this regard, the result set text, for each low level algorithm applied, may be reviewed to determine if the result set text is empty, as shown in block 603. An empty or null result set text may result in the low level algorithm not being validated. In the event the result set text is not empty or null, the low level algorithm may be validated and the process may move to block 615 to validate data with the result set text.

In the event the low level algorithm is not validated a high level algorithm may be determined and applied, as shown in block 607. The high level algorithm may include natural language processing to extract relevant data from converted text documents. Natural language processing may analyze the converted text document based on words, word groups, grammatical rules, spaces, symbols, punctuation marks, etc., to generate a result set text. High level algorithms may be defined for each client and, in some instances general high level algorithms may be used. Client high level algorithms may have different natural language processing analysis rules that the general high level algorithm. In some instances, the system may attempt the client high level algorithm before proceeding to the general high level algorithm. The data within the result set texts determined by high level algorithms may be the same or different then the data within the result set texts determined by the low level algorithms. The natural language processing may use a last updated model described further herein.

The result set text of each applied high level algorithm may be validated, as shown in block 609. In this regard, the result set text, for each high level algorithm applied, may be reviewed to determine if the result set text is empty. An empty or null result set text may result in the high level algorithm not being validated as shown in block 611 and a result set text that is not empty or null may be validated and the process may move to block 615 to validate data in the result set text.

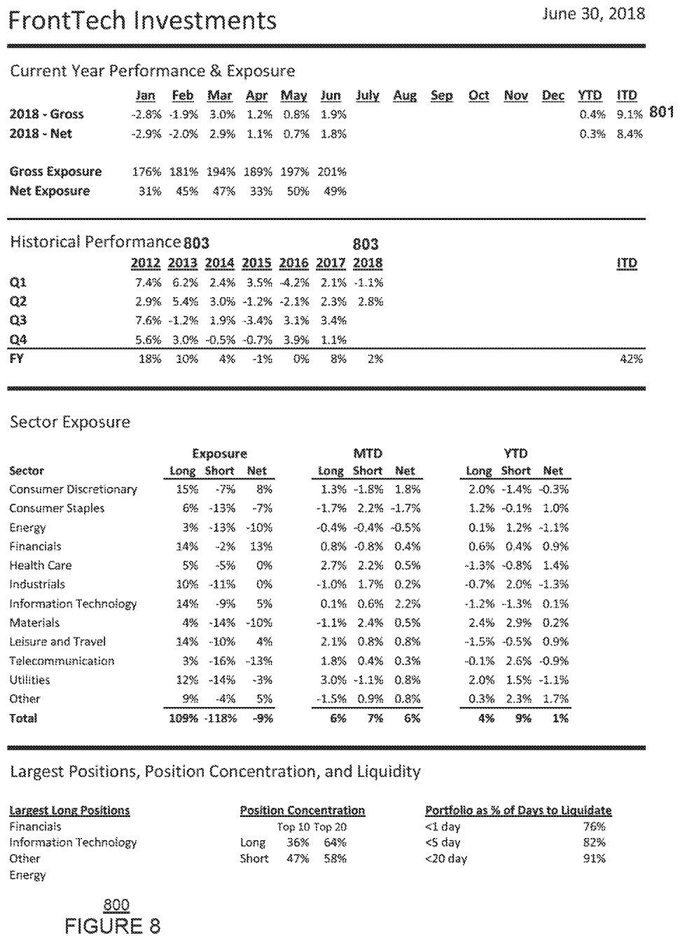

The high and/or low level algorithms may extract relevant data from tables within a document. In this regard, the high and/or low level algorithms may be able to locate a particular column and row based on the column and row's labels. From the column and row labels, the algorithms may be able to locate and extract relevant data from the tables, such as new data added to the document in comparison to an earlier version of the same document. In some instances, the algorithms may explicitly be programmed to extract all new values from particular rows and or columns of a table. For instance, a low level algorithm for FrontTech Investments fact sheets may be programmed to extract new gross and the latest historical performance. Referring to FIG. 8, a FrontTech Investments fact sheet of Jun. 30, 2018, labeled 800, may be received by the processing server. The low level algorithm will determine the row 2018—Gross, labeled 801, contains the new gross and column 802 in the historical performance section 803 includes the latest historical performance. The low level algorithm may then determine the value of 1.9% was appended onto the gross row 801 and the value 2.8% was appended into column 802 in comparison to the FrontTech Investments fact sheet of May (not shown). These appended numbers may be extracted and input into a result set text.

In the event the result set text of the high level algorithm is not validated, manual text processing may be initiated, as shown in block 613. Manual text processing may include a template building module which will prompt a user, such as user 310 or client 330 to manually select relevant data within a user interface. In this regard, the template building module may provide step by step instructions informing the user how to extract relevant data into a result set text.

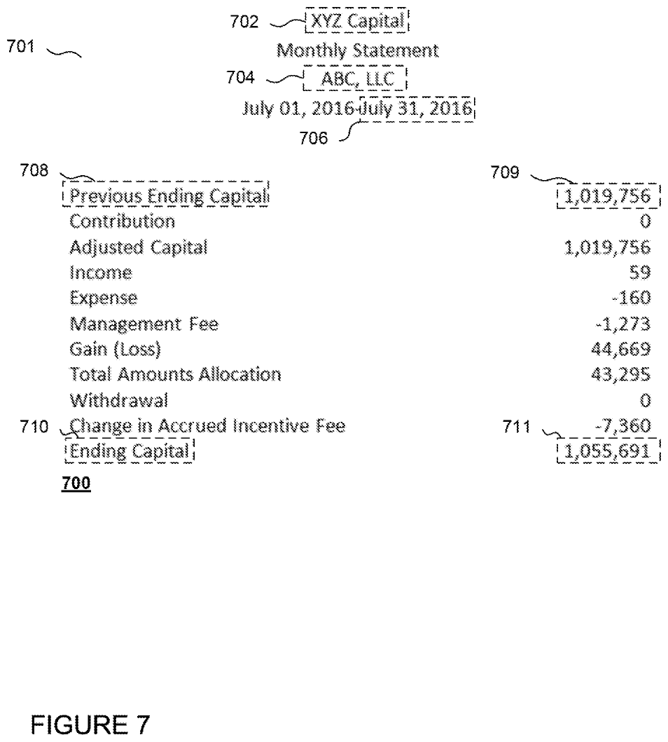

For example, referring to FIG. 7, the template building module may display an interface 700 showing the converted text document 701 created from financial statement 500. The user may select a letter, groups of letters, words, groups of words, numbers, groups of numbers, or any other element of the text. Upon selecting one or more elements of the text, the user may be prompted to associate the selection with a tag. For instance, as shown in FIG. 7, the user may select elements “XYZ Capital” 702, “ABC, LLC” 704, “July 31, 2016” 706, “Previous Ending Capital” 708, and “Ending Capital” 710. Upon selecting each element, or after selecting all of the elements, the interface may request the user provide a tag for each element. As shown in Table 2 below, each element may be assigned a tag, such as “hedgeFundName” for element 702 and “entityName” for element tagged.

In some instances, only privileged users may be capable of creating a template. In this regard, one or more individuals may be defined as a privileged user for a client or clients. Only privileged user may have permission to create, modify or delete templates. As such, only privileged user may be able to create templates which can be converted to low level algorithms.

Tags may be labeled as required or optional. In some instances, to successfully validate a result text set, as described herein, all tags labeled as required must be associated with the appropriate extracted element, while other fields labeled as optional may be missing an element. Further, certain fields may be marked as irrelevant, and during the validation process these fields may be ignored.

In some instances the template building module may include predications of tags for certain elements based on the natural language processing of the high level algorithm. A user may accept some, none, or all of the predications.

TABLE 2

| Tag | Element |
|---|---|
| “hedgeFundName” => | “XYZ Capital” |
| “entityName” => | “ABC, LLC” |
| “endingDate” => | “July 31, 2016” |
| “beginningBalance” => | “Previous Ending Capital” |
| “endBalance” => | “Ending Capital” |

Elements may be associated with other elements. In this regard, a tagged element may be associated with another untagged element. For example, tagged element 708 “Previous Ending Capital may be associated with element 709 “1,019,756” and tagged element 710 “Ending Capital” may be associated with element 711 “1,055,691”. Similarly, untagged elements may be associated with other untagged elements. The interface may associate elements together by receiving input of a selection of first element followed by input of a selection of a second element.

A result set text may be generated based on the tagged elements and associated elements. For instance, a result set text may be generated for the selected elements of converted text document 701 as shown in Table 3, where tags may be associated with tagged elements or elements associated with a tagged element. The result set text generated by manual text processing may be subjected to the same validation process as described with regard to the high level algorithm validation and/or the low level algorithm validation.

TABLE 3

| “hedgeFundName” => | “XYZ Capital” |
|---|---|
| “entityName” => | “ABC, LLC” |
| “endingDate” => | “July 31, 2016” |
| “beginningBalance” => | “1,019,756” |
| “endBalance” => | “1,055,691” |

Referring to FIG. 6, data within a result set text may be validated as shown in block 615. Validation may include comparing each piece of data in the result set text in view of historical validated data stored in a database, such as database 254. In this regard, for each piece of data the processing server may determine whether the piece of data is equal to or within a particular range of historical validated data. In some instances all or a predetermined amount of data within the result set text may need to be validated to validate the entire result set text. For example, the processing server 210 may validate a portion of the result set text if data “1,019,756” from element 709 of FIG. 7 is determined to be equal to a value associated with an “endBalance” tag from an immediately prior financial statement.

As shown in block 617 of FIG. 6., in the event the result set text is not validated, the process may pass to block 619 where an error notification may be provided to the client 330 or a user 310. Otherwise, upon validating the result set text the data within the result set text may be stored in the validated data database 254 as validated data, as shown in block 621. Furthermore, a low level algorithm may be generated for the document 500. In this regard, upon the result text set generated by the template building module being validated, a low level algorithm which tracks the results of the template building module may be generated and stored in the algorithm database 251 for future retrieval.

During the validation process if any of the tags labeled as required fail validation, the system may inform user, such as a privileged user or user 310, that data can be extracted but fails validation. A user may then investigate the issue and perform appropriate remedial actions. Furthermore, if a result set text based on a document fails validation, the result set text will not be used for or reporting and the document may be marked as unprocessed. Users may be able to filter and view all unprocessed documents.

In the event a high level algorithm is used to successfully extract and validate data of a document, a new low level algorithm may be generated. During batch processing, any time a new low level algorithm is generated, the low level algorithm may be tried on the immediately subsequent document. Should the low level algorithm be unsuccessful or result in data not being validated, the other low level algorithm and, possibly, high level algorithms may be attempted. In the event a high level algorithm is successful, a new low level algorithm may be created and the process may repeat.

When new templates are created, historical documents not previously processed, may be subjected to processing through the new template. Such historical documents may refer only to those unprocessed documents categorized to particular funds, entities, users, etc. Further when new fields are added to a template, all or some of the historical documents may be reprocessed.

Subsequently or simultaneously to storing the validated data, the processing server 210 may execute a computation module to create a finalized dataset which may be presented to the client 330 and stored in a core database, such as database 253. In this regard, the finalized dataset may include only relevant information extracted from the document received by the client. This relevant information may be arranged according to a predefined format and be transmitted to the client 330.

Validated data may be used for data integrity analysis and data abnormality detection. For example, the processing server may extract two hundred documents, such as financial monthly reports for one particular hedge fund. The extraction of these financial reports may be associated with each communication document which contained the financial reports. The data in the communication document may be compared with the associated financial report which was included in the communication document to assure the financial report includes expected data. For instance, the communication document may include a note that the financial report is for May 2015, but the financial report may include a date of February 2015. In this scenario, the processing server 210 may generate an alert and/or notification to client 330, user 310, and/or entity user 320 to verify the data within the communication document and associated report.

In another example, data in extracted documents may be compared. For instance, a financial report of May 2015 may state an account ending balance of $1,500,000 and a financial report of June 2015 may state an account beginning balance of $1,000,000. The discrepancy between the ending balance and starting balance may be determined by the processing server 130, and an alert and/or notification may be sent to client 330, user 310, and/or entity user 320 to verify the data within reports.

In yet another example, the system may detect anomalies based on discrepancies between multiple documents. For instance, a client may receive two capital call notices in a first quarter. The first capital call notice may show a value of $100 and the second capital call notice showing a value of $50. Both capital call notices may be validated as described herein. Subsequent to the validation of both capital call notices, a first quarter summary may be received with a total capital call value for the quarter being listed as $200. The system may validate the first quarter summary document. However, the system may run a validation on the extracted data from the first quarter summary based on the historical data of the first and second capital call notices, and determine a discrepancy between the $200 total capital call value for the quarter in view of the $150 capital call notices of the first and second notices. When such a discrepancy or anomaly is determined, an alert may be sent to the client or other such user.

In some instances, a user can define anomaly detection rules. For instance, a user may define a return for a particular fund cannot be more than 100% per month. In some examples, the system may run an anomaly detection across documents of multiple clients. For instance, ten clients may invest in fund A and nine of the ten clients may receive 5% returns every quarter. However, the tenth user may receive a 20% return every quarter. This anomaly may be detected by the system and reported to the users or certain user.

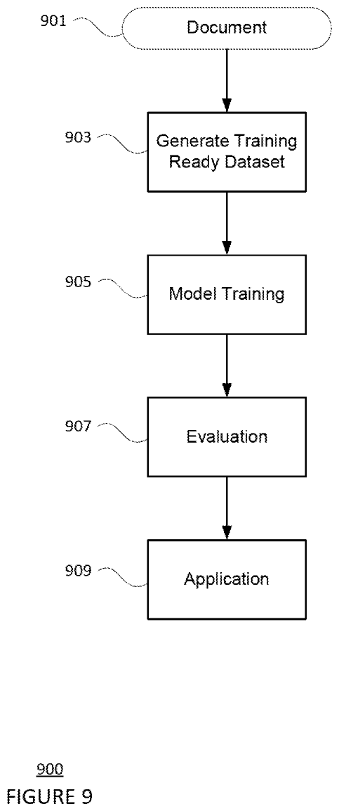

Data from extracted documents may be compared to calculations performed by the processing server 130. For instance, an annual report, including an annualized return amount, may be compared to an annualized return amount calculated by the processing server 130 based on financial reports provided during the time period covered by the annual report. In the event the annualized return amount does not match the annualized return amount calculated by the processing server 130, an alert and/or notification may be sent to client 330, user 310, and/or entity user 320. The processing server may continually update and generate new low and high level algorithms using machine learning as shown in the flow diagram of FIG. 9. In this regard, each time the processing server 210 receives a new document 901, the document may be converted to text, as described herein, and a training ready dataset may be generated. In some instances, a new training set may be generated after the system received 15% to 20% more documents, or more or less, than are currently in the training set. Generating a training ready dataset from the converted text document, as found in block 903, may include separating all the words, symbols, numbers, etc., into groups based on grammatical rules, such as spaces, newline symbol, and punctuation marks. For example, referring again to the document of FIG. 5, “July 01, 2016” will be considered one group while “Monthly Statement” and “ABC, LLC” may be considered two, distinct groups.

For each group, the processing server may identify what kind of part of speech the group is and whether the group is a number. The part of speech and an indicator representing whether the group is or is not a number, may be saved in association with the group. Further, the processing system may determine the position of a group, such as at the start of a line, in the middle of a line, or at the end of a line, etc. In another example, the processing system may determine what line number the group is on, what word on a line the group is, etc. The processing server may also analyze low level algorithms stored in the algorithm database 251 to determine whether a group matches a tag in the system. If so, the group may be associated with determined tag. The determined information may comprise the training ready dataset.

Model training may be performed using the training ready dataset, as shown in block 905. In this regard, the processing server may split the training ready dataset into a training set and testing set. For example, if training ready dataset has 100 data points (i.e., a tagged group,) training dataset can have 70 data points, and testing dataset can have the other 30 data points. The processing server may select regularization parameters (c1, c2) using randomized search and 3-fold cross-validation to randomly divide the data set to the training part and testing part.

Each word group may then be processed to determine certain features which would increase the ability of a low level algorithm to determine similar data. For instance, each word group may be processed to determine its identity, suffix, shape and part of speech (POS) tag. In some instances, word groups surrounding the current word group may be used for determining grammatical and location relations of the current word group, also, some information from nearby words is used.

Based on the determined features for each word group, the processing server may generate a model. The model may be fit using L-_{BFGS} training algorithm and Elastic Net regularization and feeds the training datasets into learning libraries, such as sklearn_crfsuite. In other words, the model may be fit with training data to determine coefficients in the model.

The generated model may then be evaluated, as shown in block 907. In this regard, the generated model may be saved into a database and F1 test and other such predicting valuation test may be performed on the model using the testing set. The F1 test and other such tests may access the accuracy of a generated model by analyzing inputted testing data from a testing set and recording a result. The result may be compared to a real answer of each testing point to determine the reliability of the model. In other words, the F1 test produces a score based on the reliability of the model (i.e., the higher the score, the higher the reliability.) In the event the predicting error rates of the tests ares below a threshold, the model may be determined as the latest reliable model. The latest reliable model may be saved into storage. Further, upon a predetermined amount of new data being received, a model training session would again be performed.

As described herein, every time the processing server gets a new document, it may go through low level algorithms. In the event no low level algorithms are available, a high level algorithm, such as the latest reliable model may be used to present predications for a user to confirm, as shown in block 909. The user may then confirm correct predictions and correct incorrect predictions. Upon confirming the changes, a new low level algorithm will be created. Subsequently or simultaneously the latest reliable model may be updated as outlined in FIG. 9.

1. A computer implemented method for extracting data from a document, the method comprising:
receiving, with one or more processors, the document;
converting, with the one or more processors, the document to a text format;
performing, with the one or more processors, data extraction from the converted document; and
generating, with the one or more processors, a result set including at least some of the extracted data.

2. The method of claim 1, wherein performing the data extraction includes:
receiving, with the one or more processors, a selection of text from the converted document, wherein the selection of text includes one or more portions of text; and
assigning, with the one or more processors, a respective tag to each of the one or more portions of text.

3. The method of claim 2, wherein the selection of text from the converted document is based on predefined criteria associated with a low level algorithm.

4. The method of claim 3, further comprising validating the extracted data.

5. The method of claim 4, wherein, in the event the validation of the extracted data fails:
receiving, from a user, a selection of text from the converted document, wherein the selection of text includes one or more portions of text; and
assigning, with the one or more processors, a respective tag to each of the one or more portions of text.

6. The method of claim 1, wherein prior to performing the data extraction, validating that the conversion was successful.

7. The method of claim 1, wherein the document includes one or more of tables, fields, Unicode characters, and numbers.

8. A system for extracting data from a document, the system comprising:
one or more processors configured to:
receive the document;
convert the document to a text format;
perform data extraction from the converted document; and
generate a result set including at least some of the extracted data.

9. The system of claim 8, wherein performing the data extraction includes:
receiving a selection of text from the converted document, wherein the selection of text includes one or more portions of text; and
assigning a respective tag to each of the one or more portions of text.

10. The system of claim 9, wherein the selection of text from the converted document is based on predefined criteria associated with a low level algorithm.

11. The system of claim 10, wherein the one or more processors are further configured to:
validate the extracted data.

12. The system of claim 11, wherein the one or more processors are further configured to, in the event the validation of the extracted data fails:
receive, from a user, a selection of text from the converted document, wherein the selection of text includes one or more portions of text; and
assign a respective tag to each of the one or more portions of text.

13. The system of claim 8, wherein the one or more processors are further configured to, prior to performing the data extraction:
validate that the conversion was successful.

14. The system of claim 8, wherein the document includes one or more of tables, fields, Unicode characters, and numbers.

15. A non-transitory computer-readable medium storing instructions, which when executed by one or more processors, cause the one or more processors to:
receive a document;
convert the document to a text format;
perform data extraction from the converted document; and
generate a result set including at least some of the extracted data.

16. The non-transitory computer-readable medium of claim 15, wherein performing the data extraction includes:
receiving a selection of text from the converted document, wherein the selection of text includes one or more portions of text;
assigning a respective tag to each of the one or more portions of text.

17. The non-transitory computer-readable medium of claim 16, wherein the selection of text from the converted document is based on predefined criteria associated with a low level algorithm.

18. The non-transitory computer-readable medium of claim 17, wherein the instructions further cause the one or more processors to validate the extracted data.

19. The non-transitory computer-readable medium of claim 18, wherein, in the event the validation of the extracted data fails:
receiving, from a user, a selection of text from the converted document, wherein the selection of text includes one or more portions of text;
assigning, with the one or more processors, a respective tag to each of the one or more portions of text.

20. The non-transitory computer-readable medium of claim 15, wherein prior to performing the data extraction, validating that the conversion was successful.
